(19) United States
(12) Patent Application Publication
(10) Pub. No.: US 2026/0320837 A1
(43) Pub. Date: Oct. 15, 2026

(54) BITELECENTRIC IMAGING ANALYSIS METHOD WITH COAXIAL LIGHT SOURCES FOR IN SITU DETECTION OF THREE-DIMENSIONAL CRYSTAL MORPHOLOGY DURING CRYSTALLIZATION

(71) Applicant: DALIAN UNIVERSITY OF TECHNOLOGY, Dalian (CN)

(72) Inventors: Tao LIU, Dalian (CN); Ji FAN, Dalian (CN); Tingman YAN, Dalian (CN); Haibo NIU, Dalian (CN); Yonghong TAN, Dalian (CN)

(21) Appl. No.: 19/649,584

(22) Filed: Apr. 16, 2026

Related U.S. Application Data
(63) Continuation of application No. PCT/CN2025/110795, filed on Jul. 28, 2025.

(30) Foreign Application Priority Data
Jul. 17, 2025 (CN) 202510987114.8

(51) Int. Cl. G06T 7/80; G02B 13/22; G06T 7/593; G06T 7/60; H04N 13/239; H04N 13/254; H04N 25/532

(52) U.S. Cl. CPC G06T 7/85; G06T 7/593; G06T 7/60; H04N 13/239; H04N 13/254; H04N 25/532; G02B 13/22; G06T 2207/30108; G06T 2207/30244

(57) ABSTRACT

A bitelecentric imaging analysis method with coaxial light sources for in situ detection of three-dimensional crystal morphology during crystallization. First, a stereoscopic bitelecentric imaging device solution with coaxial light sources is designed, having coaxial bitelecentric cameras with tunable numerical aperture and a collimated backlight illumination apparatus, thereby significantly expanding the common focusing region of a conventional binocular imaging solution and capturing particle images with higher contrast relative to an imaging background. Second, an in situ calibration method based on a newly designed stereoscopic calibration target is established for a binocular imaging device, to facilitate in situ calibration application within the limited environmental space of a crystallizer. Finally, a dense stereoscopic image reconstruction method is provided, which can accurately measure the three-dimensional morphology and size information of each particle in a crystallization solution.

### TECHNICAL FIELD

The present invention belongs to the technical field of industrial process control and detection, relates to an in situ image monitoring technology of industrial crystallization processes, and particularly relates to a noninvasive online monitoring system based on bitelecentric imaging with coaxial light sources, and an in situ stereoscopic calibration method for binocular bitelecentric cameras for realizing three-dimensional reconstruction and measurement of crystal particles. Specifically, the present invention relates to a bitelecentric imaging analysis method with coaxial light sources for in situ detection of three-dimensional crystal morphology during crystallization. The method uses coaxial bitelecentric lenses with adjustable depth of field to construct a sufficient common focusing region for in situ high-quality imaging and three-dimensional morphological analysis of crystals in a crystallizer solution.

### BACKGROUND

The process and the control technology of an industrial crystallization process have very important effect and significance for the high-quality development of the advanced manufacturing field. To intuitively and effectively realize real-time quality detection and crystal form regulation optimization of the crystallization process, the process analysis technology based on binocular telecentric vision has received increasing research and application in recent years. When stereoscopic telecentric vision is used to measure micro-scale (tens to hundreds of micrometers) crystal particles during crystallization, telecentric lenses with high magnifications are required. However, a high magnification corresponds to a very limited range of depth of field, which will lead to a serious shortage of the common focusing region of a binocular camera. In addition, the telecentric lenses have a constant magnification and are insensitive to the depth dimension, which brings additional challenges to camera calibration. At the same time, how to realize flexible and accurate calibration of the in situ stereoscopic telecentric imaging system under the condition of very limited calibration space is of great significance for three-dimensional crystal morphology reconstruction. There are few documents and patents at home and abroad that introduce a standardized analysis method for three-dimensional morphology detection of crystals in a crystallizer based on in situ high-quality stereoscopic microscopic imaging that can be popularized and applied.

At present, the stereoscopic microscopic detection technologies for in situ measurement of particle population size and/or shape have been developed. For example, Professor M. Mazzotti of ETH Zurich in Switzerland, et al. proposed a stereoscopic imaging method for capturing crystal images in two vertical directions through a transparent flow channel in the document “Online 3D characterization of micrometer-sized cuboidal particles in suspension” (published in Small Methods, an internationally important journal in the field of microscopic materials, 2023, 7, 2201018), and adopted machine learning to online estimate the characteristic length and direction of particles in a dilute particle flow. For another example, J. Fan et al. designed a binocular backlight imaging system to monitor the three-dimensional length and width information of crystals during continuous crystallization in a recent document “Noninvasive stereoscopic backlight imaging design for in situ measurement of particle size distribution during continuous crystallization via COBC” (published in IEEE Transactions on Instrumentation and Measurement, an internationally important journal in the measurement field, 2025, 74, 5011914). However, the common focusing region of the above stereoscopic microscopic imaging systems is very limited, and the analysis of particle images outside the common focusing range may have large measurement errors. Therefore, it is necessary to develop a more advanced stereoscopic microscopic imaging system to ensure that the in situ stereoscopic imaging of moving particles in a crystallization solution has a sufficient common focusing region and an effective measurement depth range. In addition, for example, J. J. Zhu et al. pointed out in a recent document “Nonlinear optimization considering target feature points for bitelecentric camera calibration: experimental study” (published in Applied Optics, an internationally important journal in the optical field, 2023, 62 (19), 5085-5093) that the shallow range of depth of field of the telecentric stereoscopic vision has an important impact on the calibration model parameters of the bitelecentric camera, but it is still necessary to develop a flexible and accurate stereoscopic calibration method under the restriction of calibration target movement for in situ real-time three-dimensional crystal measurement.

### SUMMARY

The technical problems to be solved by the present invention are how to perform in situ capturing of clear binocular images of microcrystal particles during crystallization of an industrial crystallizer, and how to perform accurate and convenient calibration of a stereoscopic telecentric imaging device and analyze the three-dimensional morphology of each particle. To solve these problems, a stereoscopic bitelecentric imaging system with coaxial light sources is designed to synchronously collect high-quality crystal images in a flowing solution, and corresponding technical methods for in situ calibration of a stereoscopic bitelecentric camera and three-dimensional morphology reconstruction are invented to realize in situ measurement of the three-dimensional shape and size information of the particles during crystallization.

To achieve the above purpose, the present invention adopts the following technical solution:

A bitelecentric imaging analysis method with coaxial light sources for in situ detection of three-dimensional crystal morphology during crystallization is provided. The method realizes the collection of binocular images on the basis of a designed noninvasive stereoscopic bitelecentric imaging solution with coaxial light sources. The collection device comprises two global shutter CMOS cameras, two coaxial bitelecentric lenses with different numerical apertures (NA), two high-power point light sources and two plane mirrors. First, by introducing a coaxial bitelecentric lens with a tunable numerical aperture, a common focusing region of a stereoscopic microscopic vision device is increased. Second, a collimated backlight illumination solution based on coaxial lenses and the plane mirrors is used for effectively improving the definition and the contrast of particle imaging. With respect to the established stereoscopic bitelecentric imaging system, an in situ calibration method is proposed, which provides reliable camera model parameter values. In addition, a designed stereoscopic calibration target with a predefined dihedral angle has the advantages of low cost and convenient practical application. Accurate binocular camera calibration parameters can be obtained with only one pair of calibration target images, so the method is more suitable for in situ calibration in the case of extremely limited space. Finally, based on the high-quality binocular images collected after calibration, a dense stereoscopic image reconstruction method is used to accurately measure the particle shape in the three-dimensional space of the crystallizer. The method comprises the following steps:

Step 1: design of a stereoscopic bitelecentric imaging system with coaxial light sources

To realize direct imaging of particles outside a crystallizer, the stereoscopic bitelecentric imaging system with coaxial light sources comprises a noninvasive stereoscopic imaging system and a collimated backlight illumination apparatus.

The noninvasive stereoscopic imaging system comprises two industrial global shutter CMOS cameras and two coaxial bitelecentric lenses. The two coaxial bitelecentric lenses have different numerical aperture (NA) structures, one lens is a lens with a fixed NA and the other lens is a lens with a tunable NA, so that the depth of field of the lens with a tunable NA can overlap with the depth of field of the lens with a fixed NA. The two lenses are combined with the two cameras to form binocular bitelecentric cameras, to provide a high magnification and form a millimeter-level field of view for each camera. Each bitelecentric camera is fixed on a four-axis micro displacement stage by a lens bracket, and aligned with the centers of the fields of view of the two cameras as much as possible through high-accuracy XYZ-axis translation and vertical rotation. In addition, two four-axis micro displacement stages are installed on a long-stroke three-axis displacement stage to facilitate the movement of a binocular camera system along X-, Y-, and Z-axes, to flexibly monitor a required particle flow region in the crystallizer.

The collimated backlight illumination apparatus comprises two high-power LED point light sources controlled by a digital stroboscopic controller and two plane reflectors; and the two point light sources with set peak wavelengths are installed in coaxial ports of the bitelecentric lenses to emit collimated beams parallel to corresponding lens barrels. Therefore, the light sources are located on the same side as the cameras through the coaxial ports. Subsequently, the generated parallel beams are reflected by the two plane mirrors installed on an adjustable light source bracket, so as to perform backlight illumination on particles in the crystallizer, to finally form a collimated backlight illumination solution and capture binocular images of particles with high contrast with the imaging background. This illumination architecture installed on the same side simplifies the system layout, and more importantly, can provide uniform and high-contrast backlight for particle imaging in the crystallizer to ensure the acquisition of high-quality particle images.

Step 2: in situ stereoscopic calibration of the binocular bitelecentric cameras
(1) Design of a stereoscopic calibration target: a used stereoscopic calibration target is a roof structure composed of two transparent glass panels, and micro-scale checkerboard patterns are processed on the two panels by a laser etching process. Each pattern comprises evenly spaced squares to form a plurality of corner points. The dihedral angle σ of the double-plane calibration target is set as about 170°, which can be completely located in the common focusing region of the above binocular bitelecentric cameras. During in situ calibration of the binocular bitelecentric cameras, the designed double-plane calibration target can be simply inserted into a measurement region, including a limited space such as a crystallization reactor or a crystallization tube, by using a stainless steel rod with a custom length to realize the in situ calibration of the imaging system.
(2) Parameter estimation of calibration models: to determine the optimal parameters of an imaging model of the binocular bitelecentric cameras, comprising an internal parameter I_{c}, a distortion coefficient vector d_{c}, a rotation matrix R_{c}, a translation vector t_{c} (wherein c∈(L, R), i.e., a left camera and a right camera) and structural parameters between the two cameras, a new stereoscopic bitelecentric camera calibration method is proposed based on the above stereoscopic calibration target to perform model parameter estimation. Specifically, a global internal parameter and a global distortion coefficient vector are solved by a least square method, and the sign ambiguity of the rotation matrix is eliminated by using the dihedral angle constraint of the stereoscopic calibration target. Based on the characteristic that the centers of the telecentric cameras are at infinity, the structural parameters of the binocular system are simplified from 6 variables to 4 variables for solving. The complete calibration process is divided into six steps of estimating an affine homography matrix, solving a global internal parameter matrix, recovering a rotation matrix, selecting the initial values of distortion coefficients, optimizing calibration model parameters and determining the structural parameters of the stereoscopic imaging system.

Step 3: dense stereoscopic image reconstruction of particle shape

According to the calibrated stereoscopic bitelecentric imaging system with coaxial light sources, binocular crystal images during crystallization are collected, and the image pair of each particle in the images is segmented and identified. Then, to realize the three-dimensional shape and geometric reconstruction of the particles, a dense stereoscopic matching method named StereoAnything is adopted, which can provide zero-shot generalization and high-quality disparity estimation for stereoscopic particle images. Subsequently, a three-dimensional point cloud is reconstructed based on the parameters of the calibrated stereoscopic imaging system.

The shapes, the sizes, the surface area and the volumes of the particles can be characterized in a three-dimensional space according to the obtained depth information of the particles. For example, to measure the length of the particles, it is considered that the three-dimensional coordinates of a particle contour are extracted from the results of the dense stereoscopic image reconstruction. Three-dimensional contour points are used for constructing a fitting plane. Each three-dimensional contour point is projected onto the fitting plane to form an optimal fitting bounding box enclosing the projected particle contour, and the length of the particle is determined according to the length of a long side thereof.

The present invention has the following beneficial effects: the present invention can realize noninvasive high-quality imaging monitoring of the solution during crystallization in the industrial crystallizer, thereby accurately acquiring the three-dimensional morphology and size information of moving particles in the crystallizer, effectively increasing the common focusing region of stereoscopic telecentric vision, and accurately measuring the three-dimensional size information of the crystal particles. The method has strong operability and low requirements for empirical technology, can achieve the effect of automatic measurement of three-dimensional crystal morphology during industrial crystallization, and facilitates practical batch and continuous application.

### DESCRIPTION OF DRAWINGS

FIG. 1(a) is a schematic diagram of an image collection platform for in situ measurement of flowing particles in the present invention, and FIG. 1(b) is a schematic diagram of a stereoscopic bitelecentric camera with coaxial light sources in the present invention;

FIG. 2 is a schematic diagram of a common focusing region of a stereoscopic microscopic vision system in the present invention: (a) in FIG. 2 is a bitelecentric lens with a fixed numerical aperture, (b) in FIG. 2 is a bitelecentric lens replaced with a tunable numerical aperture, (c) in FIG. 2 is a schematic diagram of a reduced common focusing region of a bitelecentric lens with a fixed numerical aperture, and (d) in FIG. 2 is a schematic diagram of an increased common focusing region after introducing a bitelecentric lens with a tunable numerical aperture;

FIG. 3 is a schematic diagram of a double-plane stereoscopic calibration target of the present invention: (a) in FIG. 3 is a front view, and (b) in FIG. 3 is an enlarged view of two micro-scale checkerboard patterns;

FIG. 4 is a diagram of sign correction for four possible pose pairs of rotation vectors in a binocular bitelecentric camera in the present invention;

FIG. 5 is a schematic diagram for determining relative poses of structural parameters of a binocular bitelecentric camera in the present invention;

FIG. 6 is a schematic diagram of particle characterization by dense stereoscopic image reconstruction in the present invention: (a) in FIG. 6 is a particle image pair, (b) in FIG. 6 is a reconstructed point cloud, and (c) in FIG. 6 shows a reconstructed three-dimensional particle contour and a length thereof calculated in a three-dimensional space;

In the figures: 1 micro particle image collection platform; 2 binocular bitelecentric camera; 3 collimated backlight illumination apparatus;
A optical bench; B coaxial port; C point light source; D plane mirror; E glass tube;
F digital stroboscopic controller; G lens with fixed numerical aperture; H lens with tunable numerical aperture;
I four-axis micro displacement stage; J three-axis optical displacement stage; K adjustable light source bracket; L magnetic stirrer.

### DETAILED DESCRIPTION

To better understand the technical solution of the present invention, the implementations of the present invention will be described below in detail in combination with drawings.

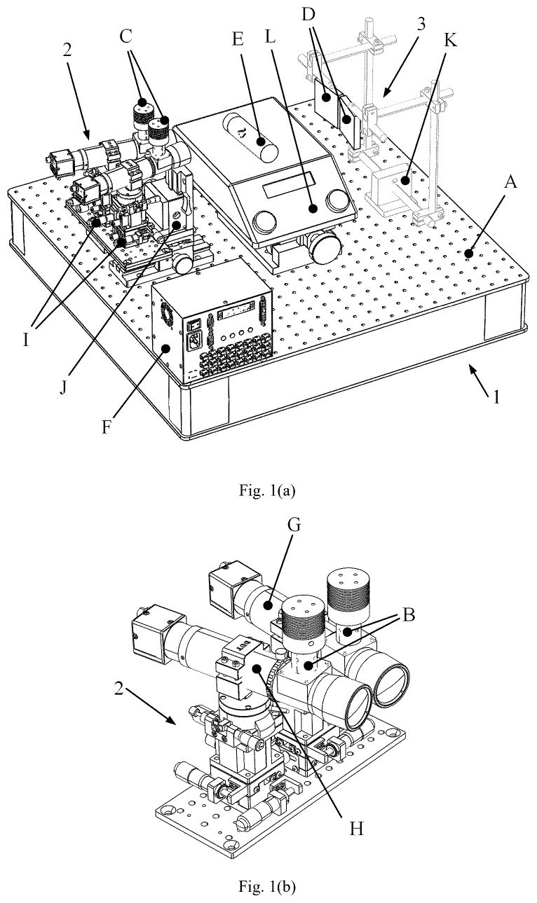

In the method, first, a stereoscopic bitelecentric imaging system with coaxial light sources is designed, and installed on a standard optical bench A to form a micro particle image collection platform 1. A specific imaging solution comprises binocular bitelecentric cameras 2, two point light sources C inserted into coaxial ports B of lenses, and two plane mirrors D, which synchronously collect microcrystal images in a flowing solution at two different angles outside a glass tube E, as shown in FIG. 1(a) and FIG. 1(b). Second, with respect to a built micro binocular bitelecentric imaging system, a new stereoscopic calibration target is designed, which can realize accurate affine camera calibration based on a single image pair for the binocular bitelecentric cameras 2 under the conditions of limited calibration object movement and micron-level depth of field. Then, for a calibrated stereoscopic imaging device, high-definition binocular images of crystals in the glass tube or a crystallizer are captured. Second, a dense stereoscopic image reconstruction algorithm for particle shape is proposed to reconstruct the surface morphology of each crystal image. Finally, by quantifying the reconstructed three-dimensional contour points of the crystals, the size information such as the length of the crystals in a three-dimensional space can be obtained.

The designed stereoscopic bitelecentric imaging system with coaxial light sources is a noninvasive industrial in situ detection instrument, which can be used for the monitoring of an industrial crystallizer, such as a continuous oscillatory baffled crystallizer (COBC). The crystallizer is composed of a plurality of jacketed glass straight tubes, and a crystal solution flows continuously through the straight tubes for crystal growth. During crystallization, a plurality of temperature controllers are arranged to adjust a plurality of temperature regions to decrease in sequence respectively, so as to realize continuous cooling crystallization. To realize in situ measurement of crystal particles in a suspended and flowing state, a stereoscopic imaging system with coaxial light sources is designed, comprising coaxial binocular bitelecentric cameras 2, LED point light sources C and plane mirrors D to provide stable, uniform and parallel backlight. During monitoring, a sufficient common focusing region of the binocular bitelecentric imaging system is realized to ensure that the collected crystal particles have consistent high definition in the binocular images. In addition, a digital stroboscopic controller F is used to send signals to achieve that the two cameras synchronously collect binocular images during crystallization when the two light sources are turned on at a hardware level. Then, the optimal model parameters of the binocular bitelecentric cameras 2 are obtained by using a proposed in situ stereoscopic calibration algorithm. Finally, the three-dimensional length size of the crystals is acquired through a proposed dense stereoscopic image reconstruction analysis method.

The method specifically comprises the following steps:

Step 1: design of a stereoscopic bitelecentric imaging system with coaxial light sources

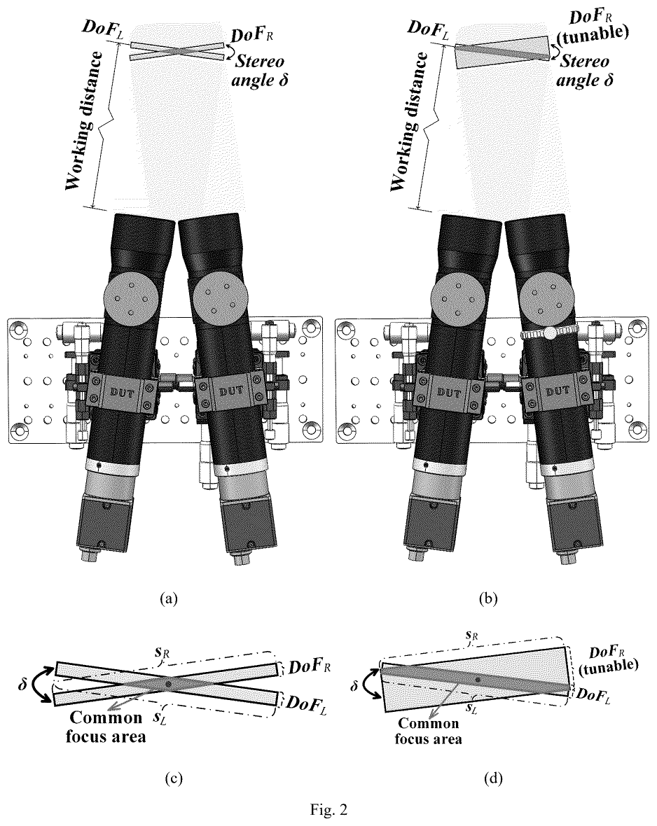

First, a stereoscopic bitelecentric imaging system with coaxial light sources is designed. The device is fixed on the standard optical bench A to form a laboratory-grade micro particle image collection platform 1, so as to test the designed stereoscopic imaging device and provide test guidance for monitoring various industrial-grade crystallizers. To realize direct stereoscopic imaging of particles outside the crystallizer, the constructed noninvasive stereoscopic imaging device comprises two industrial-grade global shutter CMOS cameras with a resolution of 2048×2448 pixels and a pixel size of 3.45 μm; two coaxial bitelecentric lenses both have a working distance of 110 mm, but have different numerical aperture (NA) structures; and two high-power LED point light sources C controlled by a customized digital stroboscopic controller F, and two plane mirrors D are arranged. Specifically, the coaxial bitelecentric system is composed of a lens G with a fixed NA (with a corresponding depth of field of 0.2 mm) and a lens H with a tunable NA (with a variable range of depth of field of about 0.2 mm to 0.9 mm), so that the depth of field of the second lens can overlap with the depth of field of the first lens. The two lenses are combined with the two cameras to form the binocular bitelecentric cameras 2. The schematic comparison diagrams before and after the increase of the common focusing region are shown in (a) and (c) in FIG. 2 and (b) and (d) in FIG. 2. At the same time, the proposed camera system ensures parallel projection, thereby eliminating perspective errors on both sides of an object and the images, providing 2× magnification and forming a field of view of 3.5×4.2 mm² for each camera. Each bitelecentric camera is fixed on a four-axis micro displacement stage I (displacement accuracy: 0.01 mm; and rotation accuracy: 10 angular minutes) by a lens bracket, and aligned with the centers of the fields of view of the two bitelecentric cameras as much as possible through high-accuracy XYZ-axis translation and vertical rotation. In addition, these assemblies are installed on a long-stroke three-axis displacement stage J to facilitate the movement of a binocular camera system along X-, Y-, and Z-axes, to monitor a required particle flow region in the glass tube or the crystallizer.

Because the bitelecentric lenses can only receive parallel light rays, two collimated backlight illumination apparatuses 3 are then designed to improve the imaging quality, especially for translucent and low-reflection crystals such as glutamic acid. Two high-power green point light sources C with peak wavelengths of 521 nm are installed in coaxial ports B of the bitelecentric lenses to emit collimated beams parallel to corresponding lens barrels. It is worth noting that the light sources here are located on the same side as the lenses through the coaxial ports, and thus called coaxial light sources. Subsequently, the generated parallel beams are reflected by the two plane mirrors D installed on an adjustable light source bracket K, so as to perform backlight illumination on particles in the glass tube or the crystallizer and capture particle images with high contrast with the imaging background. It is worth emphasizing that the two cameras and two LED lamps are triggered simultaneously by pulse signals sent by the digital stroboscopic controller F to ensure that stereoscopic image pairs are acquired synchronously when the light sources are turned on for in situ detection and analysis. It is noted that the glass tube E is placed on a magnetic stirrer L to make the particles suspend and flow and maintain uniform distribution. Before in situ capturing, it is recommended to adjust to a uniform illumination background and adopt an extremely short exposure time (e.g., 5-20 μs), to obtain clear stereoscopic images of flowing particles and avoid motion blur.

Step 2: in situ stereoscopic calibration of the binocular bitelecentric cameras

Before camera-based in situ measurement is performed on the particles in a container, a microscopic vision system must be calibrated to ensure the accuracy of the measurement. To cope with the limited operation space of in situ camera calibration imaging in practical engineering application, an in situ calibration method based on a specially designed stereoscopic calibration target is proposed.

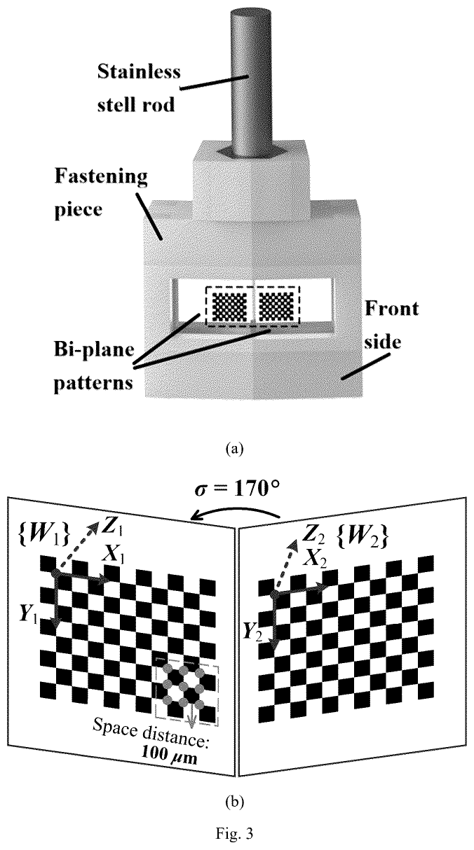

The schematic diagram of the designed stereoscopic calibration target is shown in FIG. 3. The calibration target has a roof structure composed of two transparent glass panels with a thickness of 1.5 mm, and each panel is laser-engraved with a micro-scale checkerboard pattern. Both sides of the calibration target have high flatness. Each micro-scale calibration pattern comprises evenly spaced 9×11 squares, having side lengths of the squares of 100 μm, to form 80 (8×10) corner points. As shown in (b) in FIG. 3, green dots in the dashed box indicate the positions of 9 sample corner points (located at the intersections of black squares). The dihedral angle σ of the double-plane calibration target is set as about 170°, which can be completely located in the common focusing region of the above binocular bitelecentric cameras. It is worth noting that to maintain the specified dihedral angle, a 3D printed fixing member is used to fix the double-plane target, as shown in (a) in FIG. 3. The double-plane patterns are represented by two coordinate systems {W₁} and {W₂} respectively, as shown in (b) in FIG. 3, so as to solve the problem that it is difficult for the patterns to obtain an accurate rigid body transformation relationship in a single three-dimensional coordinate system. The designed stereoscopic calibration target not only avoids the problem of inherent defects in the calibration of telecentric cameras using two-dimensional calibration plates, but also eliminates the need to manufacture an extremely accurate three-dimensional calibration cube.

During in situ calibration of the binocular bitelecentric cameras, the proposed double-plane calibration target can be conveniently inserted into a crystallization measurement region (common focusing region), such as the above glass tube or the crystallizer, by using a stainless steel rod with a customized length, to capture a calibration image pair in which two plane patterns are clearly visible. The configuration of the stereoscopic calibration target enables all internal, external and spatial structural parameters of the stereoscopic telecentric imaging system to be solved with a single calibration capturing (single pose). It is noted that the front of the double-plane calibration target should face the two cameras during calibration.

A projection matrix of a bitelecentric camera from an object space to an image plane is:

$$[ \begin{matrix}q \\ 1\end{matrix} ] = {\underbrace{[ \begin{matrix}a & s & {u}_{0} \\ 0 & b & {v}_{0} \\ 0 & 0 & 1\end{matrix} ]}}_{I} {\underbrace{[ \begin{matrix}1 & 0 & 0 & 0 \\ 0 & 1 & 0 & 0 \\ 0 & 0 & 0 & 1\end{matrix} ]}}_{O} {\underbrace{[ \begin{matrix}{R}_{3 \times 3} & {t}_{3 \times 1} \\ {0}_{1 \times 3} & 1\end{matrix} ]}}_{E} [ \begin{matrix}Q \\ 1\end{matrix} ] = {\underbrace{I [ \begin{matrix}{R}_{2 \times 3} & {t}_{s 2 \times 1} \\ {0}_{1 \times 3} & 1\end{matrix} ]}}_{C} [ \begin{matrix}Q \\ 1\end{matrix} ] \qquad ( 1 )$$

Where Q represents a three-dimensional point (x, y, z) in the object space; q represents a two-dimensional projection point (u, v) of the three-dimensional point in the image plane; I, E, and O are an internal parameter, an external parameter and an orthogonal projection matrix of the camera respectively; C is the final projection matrix formed; α and b define the effective magnifications of the bitelecentric camera along u and v directions in the image plane respectively; s represents a skew factor of a sensor array; (u₀, v₀) can be taken as the central coordinate of the image plane, wherein the center of the bitelecentric camera is located at a point at infinity; and (R_{3×3}, t_{3×1}) represents a rotation matrix and a translation vector for transforming a point from a world coordinate system to a camera coordinate system.

Considering in situ imaging distortion, second-order and fourth-order radial distortion coefficients k₁, k₂ and the distortion coefficients I₁, I₂ and p₁, p₂ related to decentering and thin prism distortion in two directions of the camera are adopted to compensate for the combined effect of lens imaging and optical refraction:

$$[ \begin{matrix}{u}_{d} \\ {v}_{d}\end{matrix} ] = [ \begin{matrix}u \\ v\end{matrix} ] + [ \begin{matrix}u ( {k}_{1} {r}^{2} + {k}_{2} {r}^{4} ) + {l}_{1} {r}^{2} + u ( {p}_{1} u + {p}_{2} v ) \\ u ( {k}_{1} {r}^{2} + {k}_{2} {r}^{4} ) + {l}_{2} {r}^{2} + u ( {p}_{1} u + {p}_{2} v )\end{matrix} ] \qquad ( 2 )$$

where r=\sqrt{u²+v²}; (u, v) and (u_{d}, v_{d}) are undistorted and distorted pixel coordinates respectively. The above coefficients are represented by a distortion vector d=[k₁ k₂ l₁ l₂ p₁ p₂]^{T}.

To calculate the optimal parameters of an imaging model of the binocular bitelecentric cameras, i.e., an internal parameter I_{c}, a distortion coefficient vector d_{c}, a rotation matrix R_{c}, a translation vector t_{c} (wherein c∈{L, R}, i.e., a left camera and a right camera) and structural parameters of the binocular cameras, a new camera calibration method is proposed below. A complete calibration process is divided into six steps:

### (1) Estimating an Affine Homography Matrix:

The Z coordinates of all corner points of each checkerboard pattern of the double-plane target in the world coordinate system are set as zero; therefore, considering world points in the coordinate system of the double-plane calibration target {W₁} in a left view, the following can be obtained:

$$[ \begin{matrix}{q}_{\text{?}} \\ 1\end{matrix} ] = I [ \begin{matrix}{R}_{\text{?}} & {t}_{\text{?}} \\ 0 & 1\end{matrix} ] [ \begin{matrix}x \\ y \\ 1\end{matrix} ] = {\underbrace{[ \begin{matrix}{h}_{11} & {h}_{12} & {h}_{13} \\ {h}_{21} & {h}_{22} & {h}_{23} \\ 0 & 0 & 1\end{matrix} ]}}_{{H}_{A}} [ \begin{matrix}{Q}_{\text{?}} \\ 1\end{matrix} ] \qquad ( 3 )$$

$$\text{?} \text{indicates text missing or illegible when filed}$$

where Rₛ is a 2×2 submatrix at the upper left corner of the complete rotation matrix R_{3×3} in formula (1), and tₛ=[tₓ t_{y}]^{T}tₛ=[tₓ t_{y}]^{T} is a 2×1 subvector of the first two bits of the complete translation vector t_{3×1}t_{3×1}t_{3×1} in formula (1). Given a sufficient number of distorted pixel coordinates (u_{d}, v_{d}) denoted as q_{d} and corresponding two-dimensional world coordinates (x, y) denoted as QₛQₛ, 6 subitems in the affine homography matrix H_{A} can be obtained by solving an overdetermined equation through a least square (LS) method.

### (2) Solving a Global Internal Parameter Matrix:

Assuming that the CMOS camera has no skewness, first, s in I of formula (3) is initially set as 0 during solving, at this time a=b and is set as M. Subsequently, corresponding elements in formula (3) are equated, which can establish the following equation:

rⱼₖ=hⱼₖ/M (4)

Where rⱼₖ and hⱼₖ are elements in a j-th row and a k-th column in the matrices Rₛ and H_{A} respectively, j=1, 2, k=1,2.

According to the unitarity and the orthogonality of column vectors of the rotation matrix, the following can be easily deduced:

M⁴−(h₁₁²+h₁₂²+h₂₁²+h₂₂²)M²+(h₁₁h₂₂−h₁₂h₂₁)²=0 (5)

For each bitelecentric camera in a stereoscopic imaging solution, a unique solution of M is ideally expected. However, two different roots of M² may appear in the analytical solution of formula (5). In addition, M may also change for the two calibration patterns used. To solve these problems, the optimal M of the double-plane patterns can be determined by the following LS solution:

$$[ {1 [ {h}_{11}^{2} + {h}_{12}^{2} + {h}_{21}^{2} + {h}_{22}^{2} ]}_{l} ] [ \begin{matrix}{M}^{4} \\ {M}^{2}\end{matrix} ] = {[ - {( {h}_{11} {h}_{22} - {h}_{12} {h}_{21} )}^{2} ]}_{l} \qquad ( 6 )$$

where l=1, 2. Thus,

$$a = b = ( \sqrt[4]{{M}^{4}} + \sqrt{{M}^{2}} ) / 2$$

can be obtained.

### (3) Recovering the Rotation Matrix:

Once I is known, Rₛ and tₛ of each checkerboard pattern can be determined in the following way:

[Rₛ,tₛ]=I⁻¹H_{A} (7)

However, the problem of sign ambiguity will occur when the remaining elements of the matrix R_{3×3} are recovered from Rₛ, which is mainly attributed to the telecentric imaging characteristics. To intuitively describe this sign ambiguity, the rotation matrix R_{3×3} in formula (1) can be parameterized by using X-Y-Z (roll-pitch-yaw) fixed angles:

$${\begin{matrix}{R}_{3 \times 3} = [ \begin{matrix}cos θcos ϕ & cos θsin ϕ & - sin θ \\ sin ψsin θcos ϕ - cos ψsin ϕ & sin ψsin θsin ϕ + cos ψcos ϕ & sin ψcos θ \\ cos ψsinθcos ϕ + sin ψsin ϕ & cos ψsin θsin ϕ - sin ψcos ϕ & cos ψcos θ\end{matrix} ] & ( 8 )\end{matrix}}_{}$$

where ψ, θ and φ are the rotation angles of a point in the world coordinate system around X-, Y- and Z-axes respectively, and are used for obtaining the coordinates of the point in the camera coordinate system.

Rₛ is made equal to corresponding items in R_{3×3}, which can deduce:

$$\{ \begin{matrix}ϕ = a tan ( {r}_{12} / {r}_{11} ) \\ θ = \pm a cos ( \sqrt{{r}_{11}^{2} + {r}_{12}^{2}} ) \\ ψ = a sin ( ( {r}_{11} {r}_{21} + {r}_{12} {r}_{22} ) / 2 sin ( 2 θ )\end{matrix} \qquad ( 9 )$$

It can be found that there are two signs for the angle θ (the sign of Y changes with the change of θ). This means that relative to the selected world coordinate system, the left camera may have two poses, real or false, and the same is true for the right camera. Therefore, for a binocular camera, there may be four pairs of poses.

To perform accurate calibration of the stereoscopic system, it is necessary to recover real pose pairs. The following proposes that pose ambiguity is corrected by using the dihedral angle information of the double-plane calibration target. The dihedral angle σ corresponds to the rotation angle of rotating from a plane 2 to a plane 1 of the stereoscopic target around the Y-axis, as shown in (b) in FIG. 3. Therefore, in the coordinate system {W₁} (or {W₂}), the three-dimensional coordinates of all corner points of the two planes are reconstructed, so as to determine rigid body transformation between three-dimensional point sets of the two planes, i.e.:

Q₁ᵢ=R₂¹Q₂ᵢ+t₂¹ (10)

where R₂¹ and t₂¹ are a 3×3 rotation matrix and a 3×1 translation vector respectively, which are used to align a point set Q₂ᵢ to Q₁ᵢ; and i=1, 2, . . . , 80. After reconstructing all three-dimensional point data, a required transformation matrix can be solved by a method based on singular value decomposition.

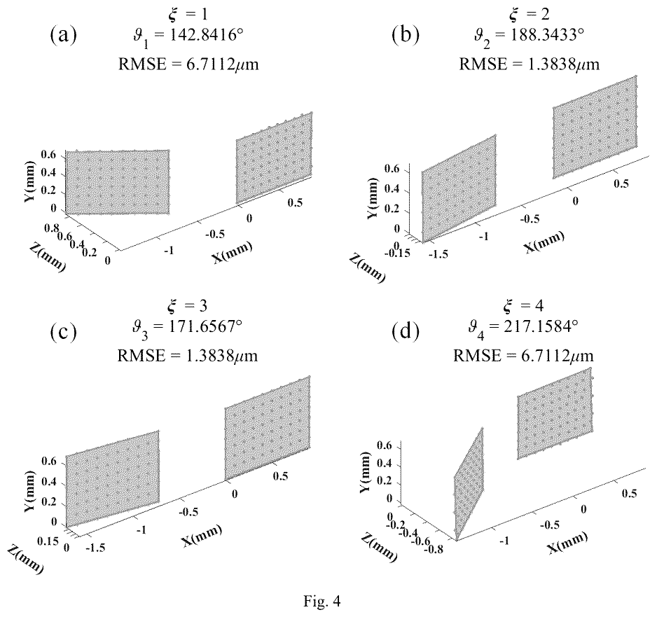

Therefore, from the obtained R₂¹, a pitch angle ϑ (i.e., a fixed angle around the Y-axis) is inversely solved, which can determine a true sign sign*(θ_{L}, θ_{R}) of the rotation angle (θ_{L}, θ_{R}) of the left and right bitelecentric cameras around the Y-axis from four candidate sign combinations shown in FIG. 4:

$${sign}^{*} ( {θ}_{L} , {θ}_{R} ) = min \vert σ - {ϑ}_{ξ} ( sign ( {θ}_{L} , {θ}_{R} ) \vert \qquad ( 11 )$$

$$where$$

$$\{ \begin{matrix}sign ( {θ}_{L} ) = + , sign ( {θ}_{R} ) = + , ξ = 1 \\ sign ( {θ}_{L} ) = + , sign ( {θ}_{R} ) = - , ξ = 2 \\ sign ( {θ}_{L} ) = - , sign ( {θ}_{R} ) = + , ξ = 3 \\ sign ( {θ}_{L} ) = - , sign ( {θ}_{R} ) = - , ξ = 4\end{matrix} \qquad ( 12 )$$

where σ=170°; and ξ=1, 2, 3, 4 represents four sign cases.

It can be seen that ϑ₃ in (c) in FIG. 4 has the smallest angular difference from σ, and the reconstruction root mean square error (RMSE) of all corner points in the two calibration planes is the smallest. Therefore, corresponding correct signs are assigned to the rotation vectors of the two cameras:

$$\{ \begin{matrix}{r}_{L} = {[ {sign}^{*} ( {θ}_{L} ) \cdot {ψ}_{L} {sign}^{*} ( {θ}_{L} ) \cdot {θ}_{L} {ϕ}_{L} ]}^{T} \\ {r}_{R} = {[ {sign}^{*} ( {θ}_{R} ) \cdot {ψ}_{R} {sign}^{*} ( {θ}_{R} ) \cdot {θ}_{R} {ϕ}_{R} ]}^{T}\end{matrix} \qquad ( 13 )$$

It should be mentioned that three elements in r_{L} and r_{R} can be equivalently converted into rotation matrices R_{L3×3} and R_{R3×3} according to a Rodrigues' rotation formula.

### (4) Selecting Initial Values of the Distortion Coefficients:

Formula (2) is converted into the following linear equation set to select a more appropriate initial value of the distortion coefficient d for each camera, i.e., an LS solution:

$$[ \begin{matrix}[ {ur}^{2} & u {r}^{4} & {r}^{2} & 0 & {u}^{2} & {uv ]}_{l} \\ [ {vr}^{2} & v {r}^{4} & 0 & {r}^{2} & u v & {{v}^{2} ]}_{l}\end{matrix} ] d = [ \begin{matrix}{( {u}_{d} - u )}_{l} \\ {( {v}_{d} - v )}_{l}\end{matrix} ] \qquad ( 14 )$$

### (5) Optimizing the Calibration Model Parameters:

To further improve the calibration accuracy in the in situ measurement of the crystallizer, i.e., to overcome the influence of image noise and distortion, the following minimization process is proposed to optimize the model parameters obtained from the above steps (1) to (4):

$$e = min {\sum }_{l} {\sum }_{i} ( \begin{matrix}{‖ {q}_{L l i}^{d} - {\tilde{q}}_{L} ( {I}_{L} , {d}_{L} , {r}_{Ll} , {t}_{Lsl} , {Q}_{l i} ) ‖}^{2} + \\ {‖ {q}_{R l i}^{d} - {\tilde{q}}_{R} ( {I}_{R} , {d}_{R} , {r}_{R l} , {t}_{Rsl} , {Q}_{l i} ) ‖}^{2}\end{matrix} ) \qquad ( 15 )$$

where e represents the sum of squared residuals between the detected corner point pixel coordinate q_{Lli}^{d} (or q_{Rli}^{d}) and a corresponding projection point \tilde{q}_{L} (or \tilde{q}_{R}) (based on the initial values of the calibration parameters calculated above); l is the number of calibration patterns; and i is the number of the corner points. The above optimization procedure can be solved by a standard Levenberg-Marquardt method.

### (6) Determining the Structural Parameters of the Stereoscopic Imaging System

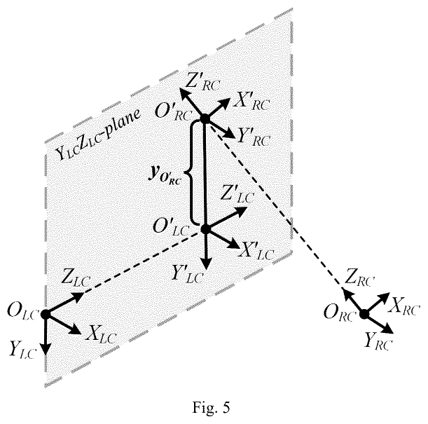

A relative rotation matrix RE of the binocular cameras can be determined on the basis of the optimized internal parameter and external parameter of the bitelecentric cameras. However, because the bitelecentric lenses are insensitive to the depth dimension, the translation vectors t_{L3×1} and t_{R3×1} have no t_{z} component, which makes it difficult to determine the relative translation vector t_{L}^{R}t_{L}^{R}. To solve this problem, a calibration strategy based on a virtual plane is provided here. In this strategy, spatial displacement between the binocular cameras is constrained only in the Y direction, as shown in FIG. 5, where O_{LC}-X_{LC}Y_{LC}Z_{LC} and O_{RC}-X_{RC}Y_{RC}Z_{RC} represent original left and right camera coordinate systems respectively, and O′_{LC}-X′_{LC}Y′_{LC}Z′_{LC} and O′_{RC}-X′_{RC}Y′_{RC}Z′_{RC} represent new left and right camera coordinate systems. It is noted that the left camera coordinate system is defined as the world coordinate system. Because the origin of the camera coordinate system can be selected at any position along the corresponding optical axis, two conditions are set for new camera origins O′_{LC} and O′_{RC}:
(1) O′_{RC} is an intersection point of a Z_{RC}-axis and a virtual plane Y_{LC}Z_{LC};
(2) O′_{LC} is a foot point passing through O′_{RC} and perpendicular to the Z_{LC}-axis.

Under these conditions, conventional t_{L}^{R} can be rewritten as:

t_{L}^{R}=−R_{L}^{R}[0y_{O′}_{_{RC}}0]^{T} (16)

where (0, y_{O′}_{_{RC}}, 0)^{T} represents the three-dimensional coordinate of O′_{RC} in the coordinate system O′_{LC}-X′_{LC}Y′_{LC}Z′_{LC}; y_{O′}_{_{RC}} represents the Y coordinate, which remains unchanged as long as the positions of the two cameras are fixed, and is deduced in the following way:

$${y}_{{O}_{RC}^{′}} = {y}_{{O}_{R C}} - {x}_{{O}_{R C}} \frac{{v}_{R y}}{{v}_{R x}} \qquad ( 17 )$$

In formula (17), v_{R}=[v_{Rx} v_{Ry} v_{Rz}]^{T} is a unit direction vector of the Z_{RC}-axis in the coordinate system O_{LC}-X_{LC}Y_{LC}Z_{LC}, and is taken from the last row of R_{L}^{R}. x_{O}_{_{RC}} and y_{O}_{_{RC}} are the XY coordinates of O_{RC} in the coordinate system O_{LC}-X_{LC}Y_{LC}Z_{LC}, and the three-dimensional coordinate (x_{O}_{_{RG}}, y_{O}_{_{RG}}, z_{O}_{_{RC}})^{T} satisfies the following condition:

$$[ \begin{matrix}{x}_{{O}_{RC}} \\ {y}_{{O}_{RC}} \\ {z}_{{O}_{RC}}\end{matrix} ] = - {( {R}_{L}^{R} )}^{T} [ \begin{matrix}{t}_{Rs} \\ 1\end{matrix} ] + [ \begin{matrix}{t}_{Ls} \\ 1\end{matrix} ] \qquad ( 18 )$$

It should be noted that [t_{Ls} 1]^{T} and [t_{Rs} 1]^{T} are calculated by formula (7) and formula (15), and the last component of the original translation vectors of the two cameras can be set as any value in implementation. Therefore, the structural parameters can be simplified as 4 independent degrees of freedom, i.e., R_{L}^{R} and y_{O′}_{_{RC}}. In practical application, it is recommended to calculate the average of the structural parameters of the two planes of the stereoscopic calibration target to construct a measurement coordinate system for microscopic three-dimensional reconstruction.

Step 3: dense stereoscopic image reconstruction of particle shape

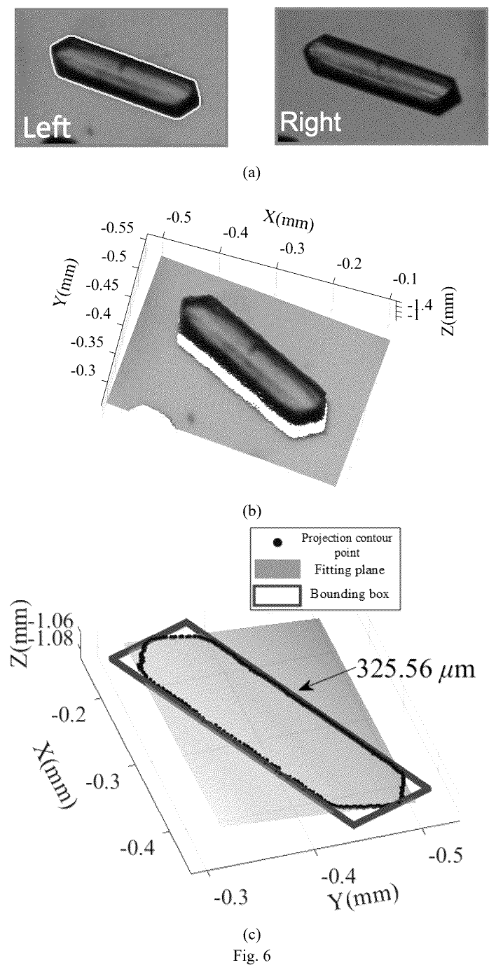

Through the stereoscopic bitelecentric imaging solution with coaxial light sources shown in FIG. 1(a), after the in situ binocular images during crystallization are collected, the image pair of each particle in the original image pair is segmented and identified. (a) in FIG. 6 shows a particle image pair with clear texture and a definite contour. To realize the three-dimensional shape and geometric reconstruction of the particles, a dense stereoscopic matching method called StereoAnything is adopted, which can provide zero-shot generalization and high-quality disparity estimation for stereoscopic particle images. Subsequently, a three-dimensional point cloud is reconstructed based on the calibrated parameters of the binocular bitelecentric cameras. (b) and (c) in FIG. 6 show the microscopic morphology and three-dimensional measurement results of the particles shown in (a) in FIG. 6.

The shapes, the sizes, the surface area and the volumes of the particles can be characterized in a three-dimensional space according to the obtained depth information of the particles. For example, to measure the length of the particles, it is considered that the three-dimensional coordinates of a particle contour (corresponding to a two-dimensional contour in (a) in FIG. 6) are extracted from the results of the dense stereoscopic image reconstruction. Three-dimensional contour points (denoted as P={(xᵢ, yᵢ, zᵢ)}ᵢ₌₁ⁿ, and n is the number of the points) are used for constructing a fitting plane, as shown in (c) in FIG. 6. Specifically, the equation of the plane in the three-dimensional space can be expressed as:

$$z = - \frac{A}{C} x - \frac{B}{C} y - \frac{D}{C} \qquad ( 19 )$$

where A, B, C and D are coefficients of the plane equation. A vertical distance from each point to the plane is defined as a residual rᵢ, and the sum of the squares of these residuals can be minimized by the following formula:

$${min}_{A , B , C , D} {\sum }_{\text{?} = 1}^{\text{?}} {r}_{\text{?}}^{2} {\sum }_{\text{?} = 1}^{\text{?}} {( {z}_{\text{?}} - ( - \frac{A}{C} {x}_{\text{?}} - \frac{B}{C} {y}_{\text{?}} - \frac{D}{C} ) )}^{2} \qquad ( 20 )$$

$$\text{?} \text{indicates text missing or illegible when filed}$$

The optimization problem is solved by LS criteria, thereby obtaining the optimal values of A, B, C and D in the fitting plane of the given three-dimensional contour points. Each three-dimensional contour point is projected onto the fitting plane to form an optimal fitting bounding box enclosing the projected particle contour, and the length of the particle is determined according to the length of a long side thereof.

The above embodiments only express the implementations of the present invention, and shall not be interpreted as a limitation to the scope of the patent for the present invention. It should be noted that, for those skilled in the art, several variations and improvements can also be made without departing from the concept of the present invention, all of which belong to the protection scope of the present invention.

1. A bitelecentric imaging analysis method with coaxial light sources for in situ detection of three-dimensional crystal morphology during crystallization, comprising the following steps:
step 1: design of a stereoscopic bitelecentric imaging system with coaxial light sources
the stereoscopic bitelecentric imaging system with coaxial light sources comprises a noninvasive stereoscopic imaging system and a collimated backlight illumination apparatus;
the noninvasive stereoscopic imaging system comprises two industrial global shutter CMOS cameras and two coaxial bitelecentric lenses; the two coaxial bitelecentric lenses have different numerical aperture (NA) structures, one lens is a lens with a fixed NA and the other lens is a lens with a tunable NA, so that the depth of field of the lens with a tunable NA can overlap with the depth of field of the lens with a fixed NA; the two lenses are combined with the two cameras to form binocular bitelecentric cameras; each bitelecentric camera is fixed on a four-axis micro displacement stage by a lens bracket, and aligned with the centers of the fields of view of the two cameras through XYZ-axis translation and vertical rotation; two four-axis micro displacement stages are installed on a three-axis displacement stage to move a binocular camera system along X-, Y-, and Z-axes;
the collimated backlight illumination apparatus comprises two high-power LED point light sources controlled by a digital stroboscopic controller and two plane reflectors; the two point light sources with set peak wavelengths are installed in coaxial ports of the bitelecentric lenses to emit collimated beams parallel to corresponding lens barrels; the generated parallel beams are reflected by the two plane mirrors installed on an adjustable light source bracket, so as to perform backlight illumination on particles in a crystallizer, to finally form a collimated backlight illumination solution and capture binocular images of the particles;
step 2: in situ stereoscopic calibration of the binocular bitelecentric cameras
(1) design of a stereoscopic calibration target: a used stereoscopic calibration target is a roof structure composed of two transparent glass panels, and micro-scale checkerboard patterns are processed on the two panels by a laser etching process; each pattern comprises evenly spaced squares to form a plurality of corner points; the double-plane calibration target is inserted into a measurement region by using a stainless steel rod with a custom length;
(2) parameter estimation of calibration models: to determine the optimal parameters of an imaging model of the binocular bitelecentric cameras, comprising an internal parameter I_{c}, a distortion coefficient vector d_{c}, a rotation matrix R_{c}, a translation vector t_{c} and structural parameters between the two cameras, a stereoscopic bitelecentric camera calibration method is proposed based on the above stereoscopic calibration target to perform model parameter estimation, wherein c∈{L, R}, i.e., a left camera and a right camera; specifically, a global internal parameter and a global distortion coefficient vector are solved by a least square (LS) method, and the sign ambiguity of the rotation matrix is eliminated by using the dihedral angle constraint of the stereoscopic calibration target; based on the characteristic that the centers of the telecentric cameras are at infinity, the structural parameters of the binocular system are simplified from 6 variables to 4 variables for solving;
step 3: dense stereoscopic image reconstruction of particle shape
according to the calibrated stereoscopic bitelecentric imaging system with coaxial light sources, binocular crystal images during crystallization are collected, and the image pair of each particle in the images is segmented and identified; then, to realize the three-dimensional shape and geometric reconstruction of the particles, a dense stereoscopic matching method named StereoAnything is adopted; subsequently, a three-dimensional point cloud is reconstructed based on the parameters of the calibrated stereoscopic imaging system;
the shapes, the sizes, the surface area and the volumes of the particles are characterized in a three-dimensional space according to the obtained depth information of the particles.

2. The bitelecentric imaging analysis method with coaxial light sources for in situ detection of three-dimensional crystal morphology during crystallization according to claim 1, wherein in (2) in step 2, a projection matrix of a bitelecentric camera from an object space to an image plane is:
$$[ \begin{matrix}q \\ 1\end{matrix} ] = {\underbrace{[ \begin{matrix}a & s & {u}_{0} \\ 0 & b & {v}_{0} \\ 0 & 0 & 1\end{matrix} ]}}_{I} {\underbrace{[ \begin{matrix}1 & 0 & 0 & 0 \\ 0 & 1 & 0 & 0 \\ 0 & 0 & 0 & 1\end{matrix} ]}}_{O} {\underbrace{[ \begin{matrix}{R}_{3 \times 3} & {t}_{3 \times 1} \\ {0}_{1 \times 3} & 1\end{matrix} ]}}_{E} [ \begin{matrix}Q \\ 1\end{matrix} ] = {\underbrace{I [ \begin{matrix}{R}_{2 \times 3} & {t}_{s 2 \times 1} \\ {0}_{1 \times 3} & 1\end{matrix} ]}}_{C} [ \begin{matrix}Q \\ 1\end{matrix} ] \qquad ( 1 )$$
where Q represents a three-dimensional point (x, y, z) in the object space; q represents a two-dimensional projection point (u, v) of the three-dimensional point in the image plane; I, E and O are an internal parameter, an external parameter and an orthogonal projection matrix of the camera respectively; C is the final projection matrix formed; a and b define the effective magnifications of the bitelecentric camera along u and v directions in the image plane respectively; s represents a skew factor of a sensor array; (u₀, v₀) is taken as the central coordinate of the image plane, wherein the center of the bitelecentric camera is located at a point at infinity; (R_{3×3}, t_{3×1}) represents a rotation matrix and a translation vector for transforming a point from a world coordinate system to a camera coordinate system;
considering in situ imaging distortion, second-order and fourth-order radial distortion coefficients k₁, k₂ and the distortion coefficients I₁, I₂ and p₁, p₂ related to decentering and thin prism distortion in two directions of the camera are adopted to compensate for the combined effect of lens imaging and optical refraction:
$$[ \begin{matrix}{u}_{d} \\ {v}_{d}\end{matrix} ] = [ \begin{matrix}u \\ v\end{matrix} ] + [ \begin{matrix}u ( {k}_{1} {r}^{2} + {k}_{2} {r}^{4} ) + {l}_{1} {r}^{2} + u ( {p}_{1} u + {p}_{2} v ) \\ u ( {k}_{1} {r}^{2} + {k}_{2} {r}^{4} ) + {l}_{2} {r}^{2} + u ( {p}_{1} u + {p}_{2} v )\end{matrix} ] \qquad ( 2 )$$
where r=\sqrt{u²+v²}; (u, v) and (u_{d}, v_{d}) are undistorted and distorted pixel coordinates respectively; the above coefficients are represented by a distortion vector d=[k₁ k₂ l₁ l₂ p₁ p₂]^{T};
to calculate the optimal parameters of the imaging model of the binocular bitelecentric camera, a complete calibration process is divided into six steps:
(1) estimating an affine homography matrix:
setting the Z coordinates of all corner points of each checkerboard pattern of the double-plane target in the world coordinate system as zero; therefore, considering world points in the coordinate system of the double-plane calibration target {W₁} in a left view, to obtain:
$$[ \begin{matrix}{q}_{d} \\ 1\end{matrix} ] = I [ \begin{matrix}{R}_{s} & {t}_{s} \\ 0 & 1\end{matrix} ] [ \begin{matrix}\begin{matrix}x \\ y\end{matrix} \\ 1\end{matrix} ] = {\underbrace{[ \begin{matrix}{h}_{11} & {h}_{12} & {h}_{13} \\ {h}_{21} & {h}_{22} & {h}_{23} \\ 0 & 0 & 1\end{matrix} ]}}_{{H}_{A}} [ \begin{matrix}{Q}_{s} \\ 1\end{matrix} ] \qquad ( 3 )$$
where Rₛ is a 2×2 submatrix at the upper left corner of the complete rotation matrix R_{3×3} in formula (1), andtₛ=[tₓ t_{y}]^{T} is a 2×1 subvector of the first two bits of the complete translation vector t_{3×1} in formula (1); given a sufficient number of distorted pixel coordinates (u_{d}, v_{d}) denoted as q_{d} and corresponding two-dimensional world coordinates (x, y) denoted as Qₛ, obtaining 6 subitems in the affine homography matrix H_{A} by solving an overdetermined equation through an LS algorithm;
(2) solving a global internal parameter matrix:
assuming that the CMOS camera has no skewness, first, initially setting s in I of formula (3) as 0 during solving, at this time a=b and setting as M; subsequently, equating corresponding elements in formula (3) to establish the following equation:
rⱼₖ=hⱼₖ/M (4)
where rⱼₖ and hⱼₖ are elements in a j-th row and a k-th column in the matrices Rₛ and H_{A} respectively, j=1, 2, k=1,2;
according to the unitarity and the orthogonality of column vectors of the rotation matrix, deducing:
M⁴−(h₁₁²+h₁₂²+h₂₁²+h₂₂²)M²+(h₁₁h₂₂−h₁₂h₂₁)²=0 (5)
wherein the optimal M of the double-plane pattern is determined by the following LS solution:
$$[ {1 [ {h}_{11}^{2} + {h}_{12}^{2} + {h}_{21}^{2} + {h}_{22}^{2} ]}_{l} ] [ \begin{matrix}{M}^{4} \\ {M}^{2}\end{matrix} ] = {[ - {( {h}_{11} {h}_{22} - {h}_{12} {h}_{21} )}^{2} ]}_{l} \qquad ( 6 )$$
where l=1,2; thus,
$$a = b = ( \sqrt[4]{{M}^{4}} + \sqrt{{M}^{2}} ) / 2$$
is obtained;
(3) recovering the rotation matrix:
with I known, determining Rₛ and tₛ of each checkerboard pattern in the following way:
[Rₛ,tₛ]=I⁻¹H_{A} (7)
parameterizing the rotation matrix R_{3×3} in formula (1) by X-Y-Z fixed angles:
$${R}_{3 \times 3} = [ \begin{matrix}cos θ cos ϕ & cos θ sin ϕ & - sin θ \\ sin ψ sin θ cos ϕ - cos ψ sin ϕ & sin ψ sin θ sin ϕ + cos ψ cos ϕ & sin ψ cos θ \\ cos ψ sin θ cos ϕ + sin ψ sin ϕ & cos ψ sin θ sin ϕ - sin ψ cos ϕ & cos ψ cos θ\end{matrix} ] \qquad ( 8 )$$
where ψ, θ and φ are the rotation angles of a point in the world coordinate system around X-, Y- and Z-axes respectively, and are used for obtaining the coordinates of the point in the camera coordinate system;
letting Rₛ equal to corresponding items in R_{3×3} to deduce:
$$\{ \begin{matrix}ϕ = a tan ( {r}_{12} / {r}_{11} ) \\ θ = \pm a cos ( \sqrt{{r}_{11}^{2} + {r}_{12}^{2}} ) \\ ψ = a sin ( ( {r}_{11} {r}_{21} + {r}_{12} {r}_{22} ) / 2 sin ( 2 θ )\end{matrix} \qquad ( 9 )$$
wherein for a binocular camera, there may be four pairs of poses;
correcting pose ambiguity using the dihedral angle information of the double-plane calibration target; wherein a dihedral angle σ corresponds to a rotation angle of rotating from a plane 2 to a plane 1 of the stereoscopic target around the Y-axis; therefore, in the coordinate system {W₁} or {W₂}, reconstructing the three-dimensional coordinates of all corner points of the two planes, so as to determine rigid body transformation between three-dimensional point sets of the two planes, i.e.:
Q₁ᵢ=R₂¹Q₂ᵢ+t₂¹ (10)
Where R₂¹ and t₂¹ are a 3×3 rotation matrix and a 3×1 translation vector respectively, which are used to align a point set Q₂ᵢ to Q₁ᵢ; after reconstructing all three-dimensional point data, solving a required transformation matrix by a method based on singular value decomposition;
inversely solving a pitch angle ϑ from the obtained R₂¹ to determine a true sign sign*(θ_{L},θ_{R}) of the rotation angle (θ_{L},θ_{R}) of the left and right bitelecentric cameras around the Y-axis from four candidate sign combinations:
$${sign}^{*} ( {θ}_{L} , {θ}_{R} ) = min \vert σ - {ϑ}_{ξ} ( sign ( {θ}_{L} , {θ}_{R} ) \vert \qquad ( 11 )$$
$$where \{ \begin{matrix}sin ( {θ}_{L} ) = + , sign ( {θ}_{R} ) = + , ξ = 1 \\ sin ( {θ}_{L} ) = + , sign ( {θ}_{R} ) = - , ξ = 2 \\ sin ( {θ}_{L} ) = - , sign ( {θ}_{R} ) = + , ξ = 3 \\ sin ( {θ}_{L} ) = - , sign ( {θ}_{R} ) = - , ξ = 4\end{matrix} \qquad ( 12 )$$
where σ=170°; and ξ=1, 2, 3, 4 represents four sign cases;
assigning corresponding correct signs to the rotation vectors of the two cameras:
$$\{ \begin{matrix}{r}_{L} = {[ {sign}^{*} ( {θ}_{L} ) \cdot {ψ}_{L} {sign}^{*} ( {θ}_{L} ) \cdot {θ}_{L} {ϕ}_{L} ]}^{T} \\ {r}_{R} = {[ {sign}^{*} ( {θ}_{R} ) \cdot {ψ}_{R} {sign}^{*} ( {θ}_{R} ) \cdot {θ}_{R} {ϕ}_{R} ]}^{T}\end{matrix} \qquad ( 13 )$$
where three elements in r_{L} and r_{R} are equivalently converted into rotation matrices R_{L3×3} and R_{R3×3} according to a Rodrigues' rotation formula;
(4) selecting initial values of the distortion coefficients:
converting formula (2) into the following linear equation set to select a more appropriate initial value of the distortion coefficient d for each camera, i.e., an LS solution:
$$[ \begin{matrix}{[ {ur}^{2} {ur}^{4} {r}^{2} 0 {u}^{2} uv ]}_{l} \\ {[ {vr}^{2} {vr}^{4} 0 {r}^{2} uv {v}^{2} ]}_{l}\end{matrix} ] d = [ \begin{matrix}{( {u}_{d} - u )}_{l} \\ {( {v}_{d} - v )}_{l}\end{matrix} ] \qquad ( 14 )$$
(5) optimizing the calibration model parameters:
$$e = min {\sum }_{l} {\sum }_{i} ( \begin{matrix}{‖ {q}_{Lli}^{d} - {\tilde{q}}_{L} ( {I}_{L} , {d}_{L} , {r}_{Ll} , {t}_{Lsl} , {Q}_{li} ) ‖}^{2} + \\ {‖ {q}_{Rli}^{d} - {\tilde{q}}_{R} ( {I}_{R} , {d}_{R} , {r}_{Rl} , {t}_{Rsl} , {Q}_{li} ) ‖}^{2}\end{matrix} ) \qquad ( 15 )$$
where e represents the sum of squared residuals between the detected corner point pixel coordinate q_{Lli}^{d} or q_{Rli}^{d} and a corresponding projection point \tilde{q}_{L} or \tilde{q}_{R}; l is the number of calibration patterns; i is the number of the corner points; and the above optimization procedure is solved by a Levenberg-Marquardt method;
(6) determining the structural parameters of the stereoscopic imaging system
determining a relative rotation matrix RE of the binocular cameras on the basis of the optimized internal parameter and external parameter of the bitelecentric cameras; to determine a relative displacement vector t_{L}^{R}, providing a calibration strategy based on a virtual plane, and constraining spatial displacement between the binocular cameras only in the Y direction, specifically as follows: O_{LC}-X_{LC}Y_{LC}Z_{LC} and O_{RC}-X_{RC}Y_{RC}Z_{RC} represent original left and right camera coordinate systems respectively, and O′_{LC}-X′_{LC}Y′_{LC}Z′_{LC} and O′_{RC}-X′_{RC}Y′_{RC}Z′_{RC} represent new left and right camera coordinate systems respectively; setting two conditions for new camera origins O′_{LC} and O′_{RC}:
(1) O′_{RC} is an intersection point of a Z_{RC}-axis and a virtual plane Y_{LC}Z_{LC};
(2) O′_{LC} is a foot point passing through O′_{RC} and perpendicular to the Z_{LC}-axis;
under these conditions, rewriting t_{L}^{R} as:
$${t}_{L}^{R} = - {{R}_{L}^{R} [ 0 {y}_{{O}_{RC}^{′}} 0 ]}^{T} \qquad ( 16 )$$
where (0, y_{O′}_{_{RC}}, 0)^{T} represents the three-dimensional coordinate of O′_{RC} in the coordinate system O′_{LC}-X′_{LC}Y′_{LC}Z′_{LC}; y_{O′}_{_{RC}} represents the Y coordinate, which remains unchanged as long as the positions of the two cameras are fixed, and is deduced in the following way:
$${y}_{{O}_{RC}^{′}} = {y}_{{O}_{RC}} - {x}_{{O}_{RC}} \frac{{v}_{Ry}}{{v}_{Rx}} \qquad ( 17 )$$
in formula (17), v_{R}=[v_{Rx} v_{Ry} v_{Rz}]^{T} is a unit direction vector of the Z_{RC}-axis in the coordinate system O_{LC}-X_{LC}Y_{LC}Z_{LC}, and is taken from the last row of R_{L}^{R}; x_{O}_{_{RC}} and y_{O}_{_{RC}} are the XY coordinates of O_{RC} in the coordinate system O_{LC}-X_{LC}Y_{LC}Z_{LC}, and the three-dimensional coordinate (x_{O}_{_{RC}}, y_{O}_{_{RC}}, z_{O}_{_{RC}})^{T} satisfies the following condition:
$$[ \begin{matrix}{x}_{{O}_{RC}} \\ {y}_{{O}_{RC}} \\ {z}_{{O}_{RC}}\end{matrix} ] = - {( {R}_{L}^{R} )}^{T} [ \begin{matrix}{t}_{Rs} \\ 1\end{matrix} ] + [ \begin{matrix}{t}_{Ls} \\ 1\end{matrix} ] . \qquad ( 18 )$$

3. The bitelecentric imaging analysis method with coaxial light sources for in situ detection of three-dimensional crystal morphology during crystallization according to claim 1, wherein in step 3, the three-dimensional coordinates of a particle contour are extracted from the results of dense stereoscopic image reconstruction; three-dimensional contour points are denoted as P={(xᵢ, yᵢ, zᵢ)}ᵢ₌₁ⁿ, where n is the number of the points, and used for constructing a fitting plane; specifically, the equation of the plane in the three-dimensional space is expressed as:
$$z = - \frac{A}{C} x - \frac{B}{C} y - \frac{D}{C} \qquad ( 19 )$$
where A, B, C and D are coefficients of the plane equation; a vertical distance from each point to the plane is defined as a residual rᵢ, and the sum of the squares of these residuals is minimized by the following formula:
$${min}_{A , B , C , D} {\sum }_{i = 1}^{n} {r}_{i}^{2} = {\sum }_{i = 1}^{n} {( {z}_{i} - ( - \frac{A}{C} {x}_{i} - \frac{B}{C} {y}_{i} - \frac{D}{C} ) )}^{2} \qquad ( 20 )$$
the optimization problem is solved by LS criteria, thereby obtaining the optimal values of A, B, C and D in the fitting plane of the given three-dimensional contour points; each three-dimensional contour point is projected onto the fitting plane to form an optimal fitting bounding box enclosing the projected particle contour, and the length of the particle is determined according to the length of a long side thereof.
